(19) United States
(12) Patent Application Publication
(10) Pub. No.: US 2004/0167882 A1
(43) Pub. Date: Aug. 26, 2004

(54) System and method for determining a user preference for a candidate

(76) Inventors: William B. Thomson, Wakefield, MA (US); William Smith, Brookline, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/672,046

(22) Filed: Sep. 26, 2003

Related U.S. Application Data
(60) Provisional application No. 60/448,825, filed on Feb. 21, 2003.

(51) Int. Cl. G06F 7/00

(52) U.S. Cl. 707/3

(57) ABSTRACT

A system for identifying a user preference for a candidate, especially for a candidate seeking election to office wherein the candidates have points of view on issues relevant in an election. The system associates attributes for a plurality of categories for each candidate and enables the user to select the attribute that reflects the user's preference for that category. After completion of the questionnaire, or when requested by the user, the system displays to the user a preference for a candidate.

### CROSS-REFERENCE TO RELATED APPLICATION

This application claims priority to and the benefit of, and incorporates herein by reference, in its entirety, provisional U.S. patent application Serial No. 60/448,825, filed Feb. 21, 2003.

### FIELD OF THE INVENTION

The invention relates generally to automated systems and methods for enabling a user to determine a preference for a candidate.

### BACKGROUND OF THE INVENTION

Various Internet-based systems that enable a user to identify a preference for a candidate out of a group of candidates based on a set of attributes are known in the art. By way of example, some conventional Internet-based systems provide assistance to users selecting automobiles. Typically, a user enters a number of preferred automotive features, and the system displays automobiles having the requisite features. For example, in an automobile selection system, the features may include size, color, year, gas mileage, cost and/or the like. Similar systems exist for other types of candidates, such as pets, homes, and boats.

However, conventional Internet-based candidate selection systems suffer from significant deficiencies. For instance, depending on the context, conventional systems tend to introduce bias when a person selects a candidate from a pool of candidates based on a set of attributes. By way of example, voters may have preconceptions about political candidates based each candidate's party affiliation and thus, find it difficult to select a particular candidate based solely on his/her actual attributes.

Another deficiency is that conventional systems do not provide a sufficient level of detail with respect to the attributes they enable users to specify. Instead, they typically enable a user to specify only general features, which may be applicable to a plurality of candidates in the set of candidates. Thus, a single set of user-selected attributes may map to a plurality of candidates.

### SUMMARY OF THE INVENTION

The invention, in one embodiment, addresses the deficiencies of the prior art by providing an improved system and related methods for determining a user preference for a candidate.

According to one aspect, the system of the invention presents candidate attributes to a user for a plurality of categories, without identifying which of the candidates is associated with which attributes. In one preferred embodiment, the candidates correspond to people seeking election to office and the categories include issues relevant in an election. The attributes include intellectual constructs, such as each candidate's points of view with respect to each of the issues. By not revealing which points of view map to which candidates until the system displays a preference for a candidate to the user, the invention reduces the user's bias towards any particular candidate during the selection process and instead forces the user to focus on the anonymous points of view for each issue.

According to a further embodiment, the system of the invention enables the user to select the attribute that most reflects the user's preference for each category. According to one feature, in response to the user selecting one or more attributes, the system determines and displays to the user a preference for a particular candidate.

According to another embodiment, the invention provides an increased level of detail with respect to attribute selection by providing summaries of the actual attributes for each of the candidates. According to one feature of this embodiment, in response to selecting a particular summary, the system of the invention presents a more detailed description of the attribute to the user. According to another feature of this embodiment, the user can select for the system to display a position paper provided by the candidate for a summarized attribute (e.g. point of view). By providing increasing levels of detail for each attribute, the system of the invention enables a user to more accurately choose between attributes. Optionally, the system presents standardized language to describe each of the candidate's attributes for each category.

According to one embodiment, the system of the invention enables the user to weight or to rank the importance of each attribute relative to the other attributes presented, and the system takes the weighting or ranking into account when scoring a user's preference for a particular candidate. According to a related embodiment, the system enables the user to skip attributes altogether.

According to a further embodiment, after the user has selected the preferred attributes for each issue, the system processes the selections along with any category weighting or ranking to determine which candidate best matches the user's selections. The system may display this determination to the user, for example, as a ranking of each candidate, a numerical preference score for each candidate, or the like.

### BRIEF DESCRIPTION OF THE DRAWINGS

The foregoing and other objects, features, and advantages of the invention described above will be more fully understood from the following description of various illustrative embodiments, when read together with the accompanying drawings. In the drawings, like reference characters generally refer to the same parts throughout the different views. The drawings are not necessarily to scale, and emphasis instead is generally placed upon illustrating principles of the invention.

FIG. 1 is a flowchart showing the steps of a system for determining a user preference for candidate, according to an illustrative embodiment of the invention.

FIG. 2 is a block diagram of a system for determining a user preference for a candidate, according to an illustrative embodiment of the invention.

FIG. 3 is a conceptual drawing of an illustrative display screen for initiating the system of FIG. 2.

FIG. 4 is a conceptual drawing of a display screen of a questionnaire, according to an illustrative embodiment of the invention.

FIG. 5 is a conceptual drawing of a display screen presenting to a user categories included in the illustrative questionnaire of FIG. 4.

FIG. 6 a conceptual drawing of a display screen for enabling the user to retrieve more details with respect to an attribute for a particular category for a particular candidate, according to an illustrative embodiment of the invention.

FIG. 7 is a conceptual drawing of a display screen for enabling the user to weight the importance of issues and to select candidates for inclusion in the questionnaire, according to an illustrative embodiment of the invention.

FIG. 8 is a conceptual drawing of a display screen for enabling the user to select attributes for a category, according to an illustrative embodiment of the invention.

FIG. 9 is a conceptual drawing of a display screen displaying to the user a candidate preference, according to an illustrative embodiment of the invention.

### DESCRIPTION OF THE ILLUSTRATIVE EMBODIMENTS

As discussed in summary above, the invention, in various embodiments, provides systems and methods for aiding a user in determining a preference for a candidate out of a plurality of candidates. Generally, a candidate may be any person, place or thing for which attributes in one or more categories are known. By way of example, candidates may be pets, automobiles, boats, homes, vacation destinations, health insurance programs, life insurance programs, education programs and/or institutions, Web sites, members of a dating service or any other person, place or thing about which attributes can be defined. However, in the following illustrative embodiment, the invention is described with respect to a candidate being a person campaigning for elected office.

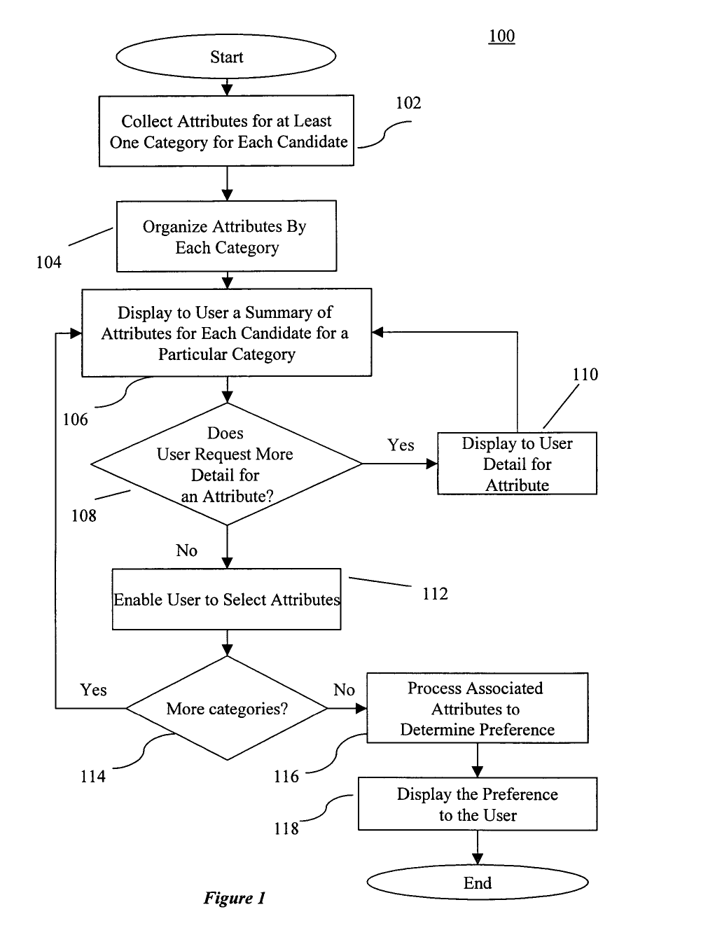

FIG. 1 is a flow diagram 100 for a candidate preference determination system according to an illustrative embodiment of the invention. As shown at steps 102 and 104, the illustrative system collects or a system administrator provides attributes for a set of categories for each candidate. Such attributes may be supplied by the candidates. Alternatively, the attributes may be collected by polling candidates or by recording observable features of the candidates. The attributes relate to specific categories, and the categories are preferably common characteristics across the pool of candidates. For example, in one illustrative embodiment, the candidates are people seeking election to office, the categories are issues relevant to the election and the attributes are intellectual constructs, such as each candidate's point of view for each issue. Preferably, the attributes provide unambiguous statements of the candidates' positions on the issues, without identifying which point of view belongs to which candidate. According to the illustrative embodiment, the language describing each candidate's points of view is used in an as-provided, unedited form from the candidates. In other illustrative embodiments, such language is standardized across candidates, so that one candidate's point of view may be readily compared to other candidates' points of view. According to one feature, information is provided with respect to a plurality of categories, and each category has at least one corresponding attribute associated with it.

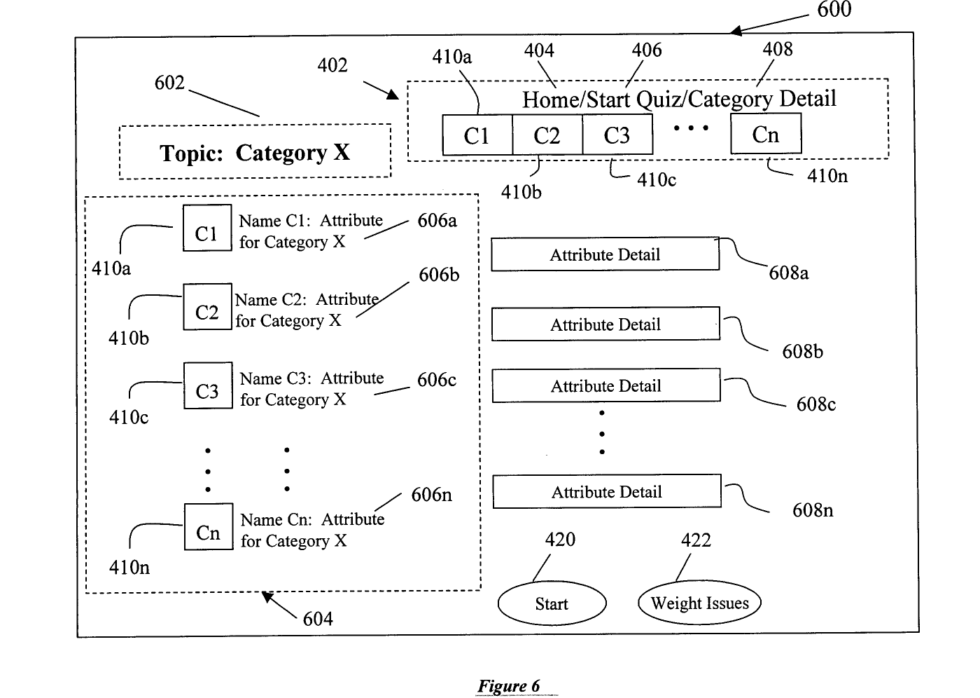

In a preferred embodiment, the system uniquely associates each attribute for each category with a single candidate. According to one feature of this embodiment, each point of view with respect to each issue is available to the user in sufficient detail so that it can be associated with only one candidate. Although the system maintains animinity of the candidate while the user is selecting attributes according to the user's preferences, optionally, as described in further detail with respect to FIG. 6, should a user wish to know which attributes map to which candidates, the information is available.

As shown in step 106, the system displays to the user a summary of attributes for each candidate for a particular category, without revealing which attribute is associated with which candidate At step 108, the user may request more detailed information for a particular candidate's attribute. In response to such a request, in step 110, the system displays to the user more detailed information (if available) for the particular attribute. In the case of a candidate being a person campaigning for elected office, the more detailed information may be, for example, a position paper written or endorsed by the candidate for a particular issue. If the user does not request more detailed information, then in step 112, the system enables the user to select the attribute that corresponds to the user's preference. According to the illustrative example, the system enables the user to select which point of view for the issue most resembles the user's. According to a related illustrative embodiment, the system enables the user to rank in order of preference the attributes (e.g., points of view) for each candidate. As shown at the decision diamond 114, if there are more categories from which attributes may be selected or ranked, the system repeats steps 106 through 112. If not, the system processes the selected attributes to determine the user's preference for a candidate at step 116. At step 118, the system displays the determined preference information to the user.

In further illustrative embodiments, the system determines and displays to the user the user's preference for each issue. According to another illustrative embodiment, the system displays a candidate ranking or relative score indicative of the user's candidate preference. Optionally, the user can rank, weight or score each issue/category based on importance and the system takes into account the ranking, weighting or scoring in determining the user's candidate preference.

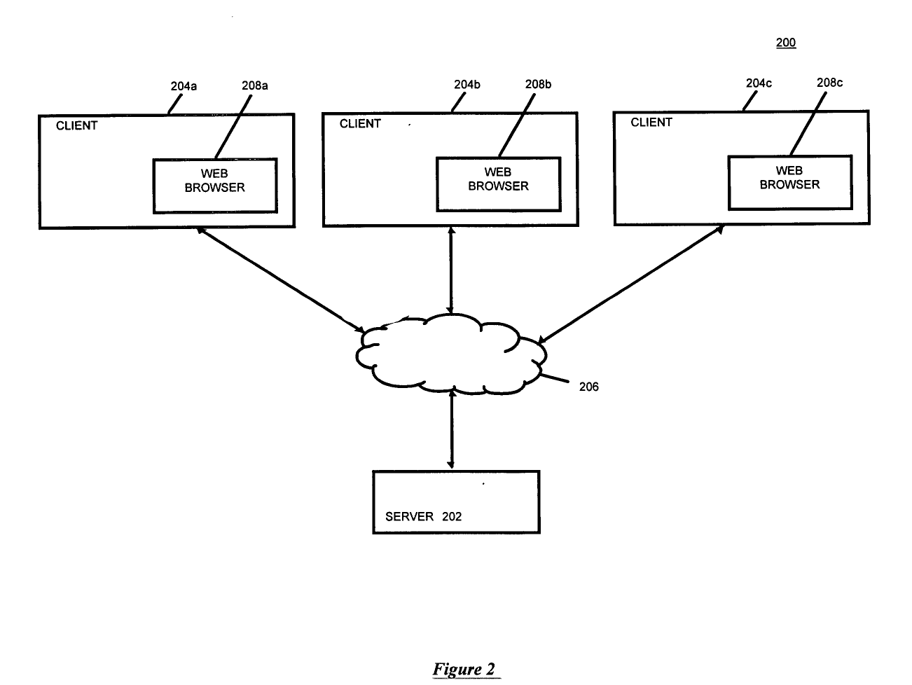

FIG. 2 is a conceptual block diagram 200 of an automated candidate preference determination system according to an illustrative embodiment of the invention. As shown, the system of the invention may be implemented in any suitable hardware/software configuration, including a client/server architecture. Preferably, the system of the invention is hosted on a server computer, such as the server computer 202, and is accessed by a user via a client computer, such as the client computers 204a-204c over a network 206.

In various embodiments, the client computers 204a-204c may be any suitable computer, such as a handheld, laptop, desk top or workstation computer. Additionally, the network 206 may be any suitable inter- or intranet, including the Internet. In the illustrative embodiment, the network 206 is the Internet, the system of the invention is hosted on a server computer 202, and the client computers 204a-204c, access the server computer 202 via Web browsers 208a-208c, respectively.

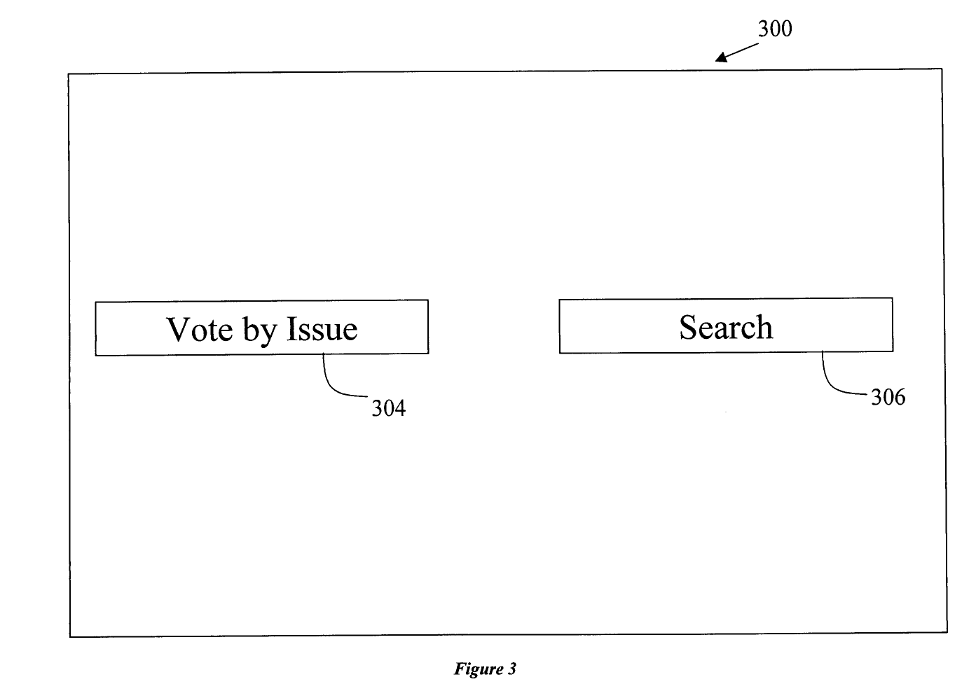

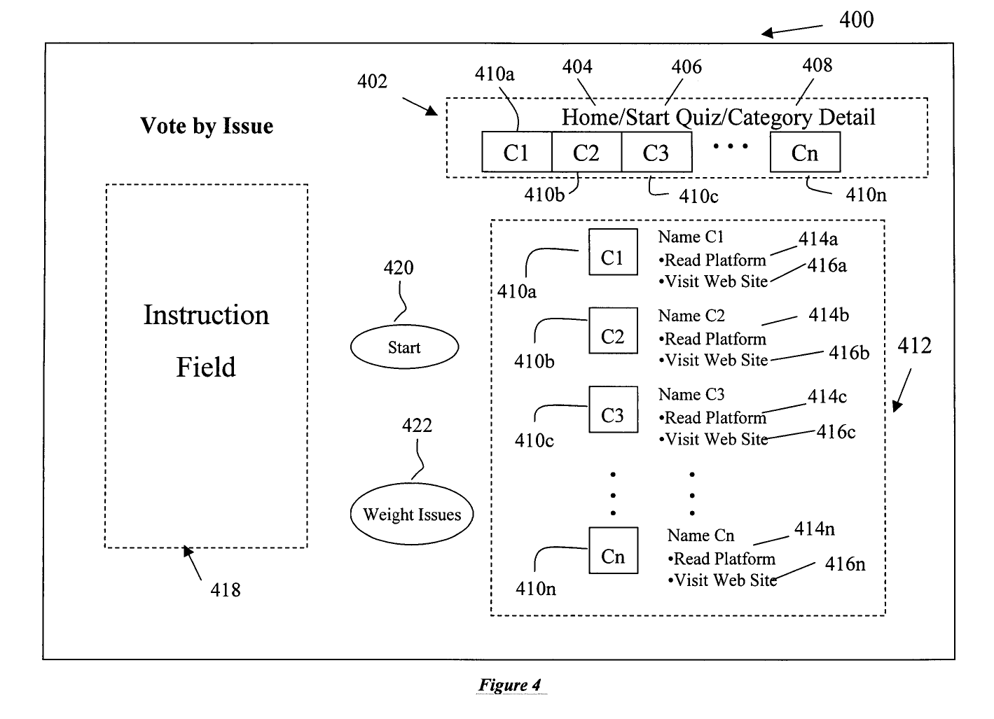

FIG. 3 is a conceptual diagram of an illustrative home page screen display 300 for enabling the user to activate the candidate preference determination system of the invention. According to the illustrative embodiment, a user can navigate to the display screen of FIG. 3 by any suitable means. To initiate the system of the invention, the user enters the term “Vote by Issue” in the search field 304 and then activates the “Search” function 306. In response, the system displays the screen 400 as shown in FIG. 4.

FIG. 4 is a conceptual drawing of an introduction display screen 400 according to an illustrative embodiment of the invention. The illustrative display screen 400 includes a main menu bar 402 providing a plurality of functions which may be employed throughout the process of answering the questionnaire. More particularly, the menu bar 402 includes a “Home” function 404, which enables the user to navigate to the home page of the Web site, a “Start Quiz” function 406, which enables the user to begin the questionnaire, and a “Category Detail” function 408, which enables the user to retrieve a summary of the categories relevant to the questionnaire. The main menu bar 402 may also include a graphical representation of each candidate 410a-410n, where n represents the total number of candidates. In the illustrative embodiment, the candidate representations 410a-410n are thumbnail photographs of the candidates. The thumbnail photographs 410a-410n are also displayed in the summary area 412. The illustrative summary area 412 also includes functions that enable the user to obtain more information about each candidate. By way of example, the summary section 412 includes a “Read Platform” function 414a-414n for enabling the user to access more detailed information regarding the candidate's position on various issues. The summary section also includes a “Visit Web Site” function 416a-416n for each candidate for enabling the user to navigate to any of the candidates' Web sites.

The introduction display screen 400 also includes an instruction field 418 for providing operating instructions to the user. The introduction display screen 400 further includes a “Start” function 420 for enabling the user to start the process of attribute selection via a questionnaire. Alternatively, the user can start the questionnaire by selecting the “Start Quiz” function 406 of the main menu bar 402. The introduction display screen 400 also provides a “Weight Issues” function 422, the activation of which navigates to a display screen that enables the user to weight or rank the relative importance of each category (e.g., issue).

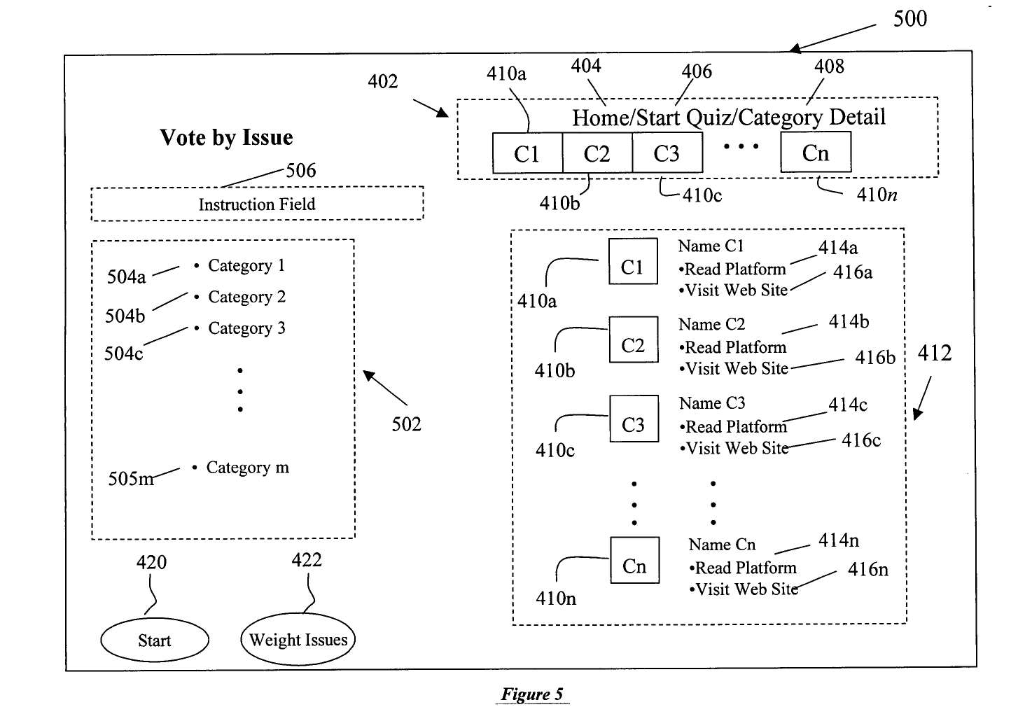

FIG. 5 is a conceptual drawing of display screen 500 presenting to a user categories included in the questionnaire. The system displays the screen 500 in response to the user selecting the “Category Detail” function 408 from the main menu bar 402. The illustrative categories screen 500 presents to the user a category column 502 which includes a list of the categories 504a-504m, for which candidate attributes are available. Preferably, the system presents at least one category to the user. In the illustrative categories screen 500, categories 504a-504m are displayed to the user, where m represents the total number of categories included in the questionnaire. The instruction field 506 describes to the user what the categories represent. In the illustrative embodiment, the categories 504a-504m represent issues relevant to an upcoming election, and the attributes are the candidates' points of view for each issue. For example, a category may be housing and an attribute for a particular candidate may be a two-sentence summary of the candidate's point of view regarding housing. Thus, a category may be an issue and the attribute an intellectual construct, such as a point of view held by particular candidate for that issue. The illustrative instruction field 506 also provides an explanation to the user about how to retrieve more information about a category.

From the categories screen 500, the user may access the functions 404, 406, and 408 on the main menu bar 402 or may invoke any of the available functions 414a-414n and 416a-416n contained within the candidate summary area 412. Also, in response to a user selecting a category, 504a-504m, the system displays more information regarding the selected category 504a-504m.

FIG. 6 is a conceptual drawing of a display screen 600 for presenting more detailed category information to the user in response to the user selecting one of the categories 504a-504m on the categories screen 500. Typically, a user does not navigate to this screen while or before taking the questionnaire, however this navigation path is available and enables the user to access additional information about specific candidate attributes. In the topic field 602, the system identifies the category selected by the user. The candidate attribute correlation panel 604 displays a representation of each candidate 410a-410n, and a summary of the attributes 606a-606n associated with each candidate for the category described in the topic field 602. The user may retrieve more detail about a candidate's attributes 606a-606n for a particular category and a particular candidate by selecting the corresponding “Attribute Detail” function 608a-608n. According to the illustrative embodiment, the attribute details are position papers each candidate has endorsed with respect to the various categories (e.g. issues).

As in the case of the introduction display screen 500, the user may navigate using the main menu bar 402, or may start the questionnaire by navigating and selecting the “Start” function 420. Alternatively, the user may navigate to the weight issues screen 700 by selecting the “Weight Issues” function 422.

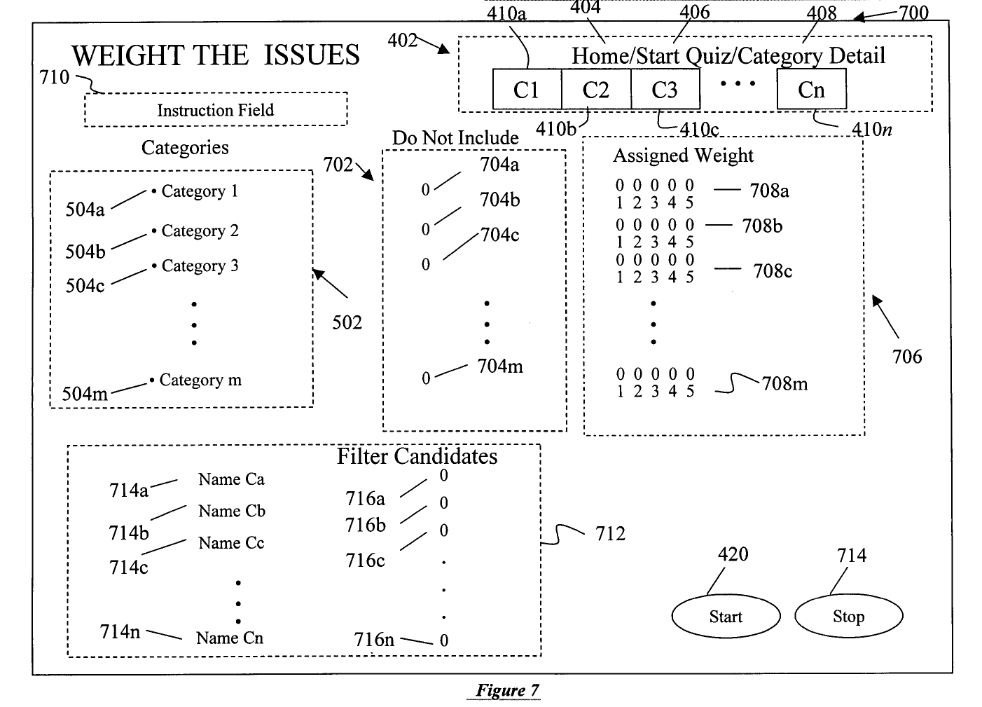

FIG. 7 is a conceptual drawing of a Weight The Issues display screen 700. The category column 502 presents the categories 504a-504m included within the questionnaire are presented to the user in the category column 502, as in the illustrative categories display screen 500 of FIG. 5. The “Do Not Include” area 702 provides exclusive select buttons 704a-704m, which each correspond to a category 504a-504m listed in the categories column 502. In response to the user selecting an exclusive select button 704a-704m, the system excludes the corresponding category from the questionnaire. In addition, the illustrative Weight The Issues screen 700 includes a weighting field 706. The weighting field 706 includes a scale 708a-708m for each category 504a-504m. The user can indicate the relative importance of a category by selecting a relative weight to be applied to each category. For example, the weighting may use a numeric scale such as 1 through 5, or a subjective scale, such as “Very Important,” “Important,” or “Not Important.” The instruction field 710 provides an explanation to the user of how to weight each category and the consequence of such weighting. For example, the instruction field 710 may indicate that selecting 1 for a category indicates that user deems the category important and selections 2-5 represent increasing degrees of importance. The scale may be any type of scale that enables the user to indicate the relative importance of the categories. According to the illustrative embodiment, importance weighting for categories may be taken into account during candidate preference determination using any suitable computational approach.

The illustrative Weight The Issues screen 700 also includes a Filter Candidates area 712, which enables the user to select the candidates the user wishes to be excluded from the quiz. In the Filter Candidates area 712 each candidate is identified by a unique identifier 714a-714n such as the candidate's name. The Filter Candidates area 712 provides exclusive select buttons 716a-716n, which each correspond to a candidate 714a-714n. In response to the user selecting an exclusive select button 716a-716n, the system excludes the corresponding candidate from the questionnaire. The instruction field 710 provides an explanation to the user of how to filter candidates out of the questionnaire.

Subsequent to the user completing any desired selections on the illustrative Weight The Issues screen, the user navigates to and selects the “Start” function 420 in the lower right corner of the screen to begin the questionnaire. Alternatively, the user may exit the system by navigating to and selecting the “Stop” function 714, or may navigate using the main menu bar 402.

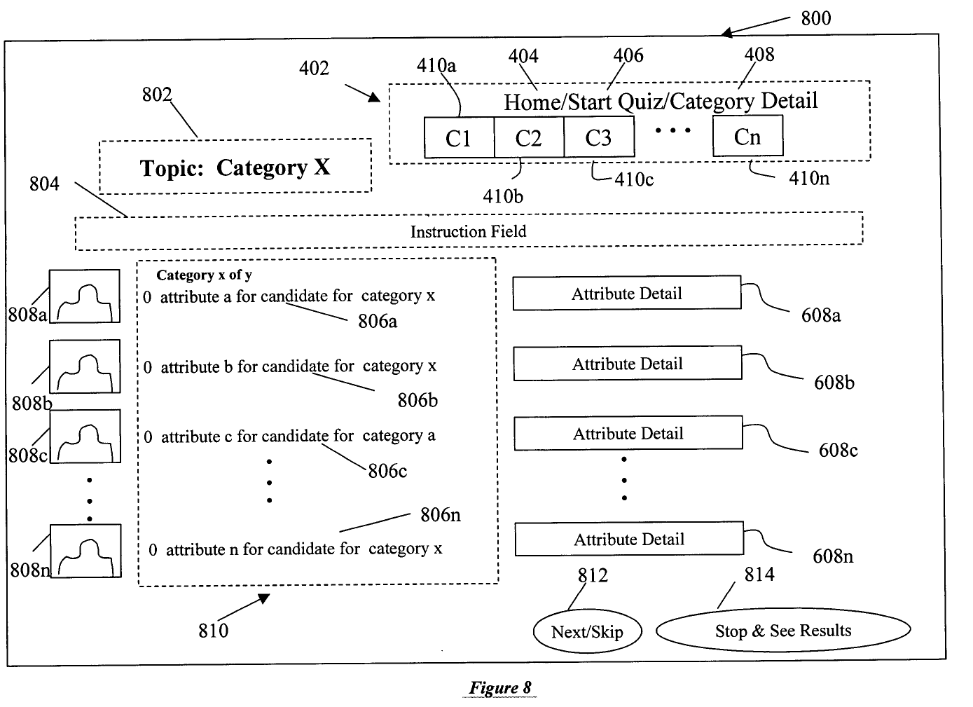

FIG. 8 is a conceptual drawing of attribute selection display screen 800 according to an illustrative ends of the invention. The display screen 800 is the first screen of the questionnaire which enables a user to express a preference for an attribute without being biased by knowledge of which candidate is associated with the particular attribute. In the instant example, each category corresponds to an issue and each attribute is a point of view of a candidate for the issue. The category identification field 802 indicates to the user the category for which the attributes are displayed. The instruction field 804 provides information to the user about how to select an attribute. In the illustrative embodiment, the attributes are unambiguous statements of the candidates' positions on issues, with no personally identifying information provided in either the attribute summary 806a-806n or by the “Attribute Detail” 608a-608n functions. In the illustrative embodiment, the instruction field 804 directs the user to select the attribute summary 806a-806n that most closely matches the user's preference with respect to the particular category. The illustrative attribute selection screen 800 includes an attribute choice field 810. According to the illustrative embodiment, the system does not identify which candidate 808a-808n maps to which attribute summary 806a-806n. The icons 808a-808n are the same for every candidate, thus, further indicating that the candidate associated with an attribute summary is not revealed to the user while he or she selects preferred attributes. The “Attribute Detail” functions 608a-608n enable the user to retrieve more detailed information about each associated attribute 806a-806n on-line while completing the questionnaire. For example, in response to the user navigating to and invoking the “Attribute Detail” function 608b, the system retrieves and presents more information about the corresponding attribute 806b. The “Attribute Detail” functions 608a-608n provide the same information as described in FIG. 6 above, such as a position paper. However, unlike the display screen as described in FIG. 6, according to this illustrative embodiment, the system does not identify to the user which candidate is associated with which position paper.

There are many ways this information may be presented. For example, in one illustrative embodiment, in response to a user selecting an attribute 608a-608n, the system provides a pop-up screen displaying the requested detailed information about the selected attribute. The user returns to the selection screen by closing the pop-up screen. In the illustrative embodiment, in response to the user selecting an attribute for a category, the system indicates that the selection has been made by shading the corresponding selection. According to another illustrative embodiment, the user may select more than one attribute available in the attribute choice field 810, and rank their preference for each attribute. By way of example, if there are five attributes in the attribute choice field 810 for the category identified in field 802, the user may assign a ranking, such as 1-5, to each attribute. A 1 ranking may, for example, indicate the attribute that is the user's most preferred attribute and rankings of 2 through 5 represent decreasing degrees of preference. Such ranking may be taken into account during preference determination using any suitable computational approach.

After the user has indicated his or her selection of an attribute for the category 802, or elected not to enter a selection for the category 802, then the user can navigate to and select the “Next/Skip” function 812. According to the illustrative embodiment, the “Next/Skip” function 812 enables the user to navigate to the next category in the questionnaire if any categories remain. If the user has not indicated a preferred attribute before selecting the “Next/Skip” function 812 by selecting the corresponding attribute 806a-806n, the system does not include that category in the summary of results. According to another feature of this embodiment, the system presents each category in substantially random or pseudo random order.

In response to the user selecting the “Next/Skip” function 812, the system presents the attribute selection screen 800 for the next category included in the questionnaire, until the system has presented all of the categories or until the user invokes the “Stop & See Results” function 814. According to the illustrative embodiment, the “Stop & See Results” function 814 enables the user to stop the system and view the results tabulated thus far.

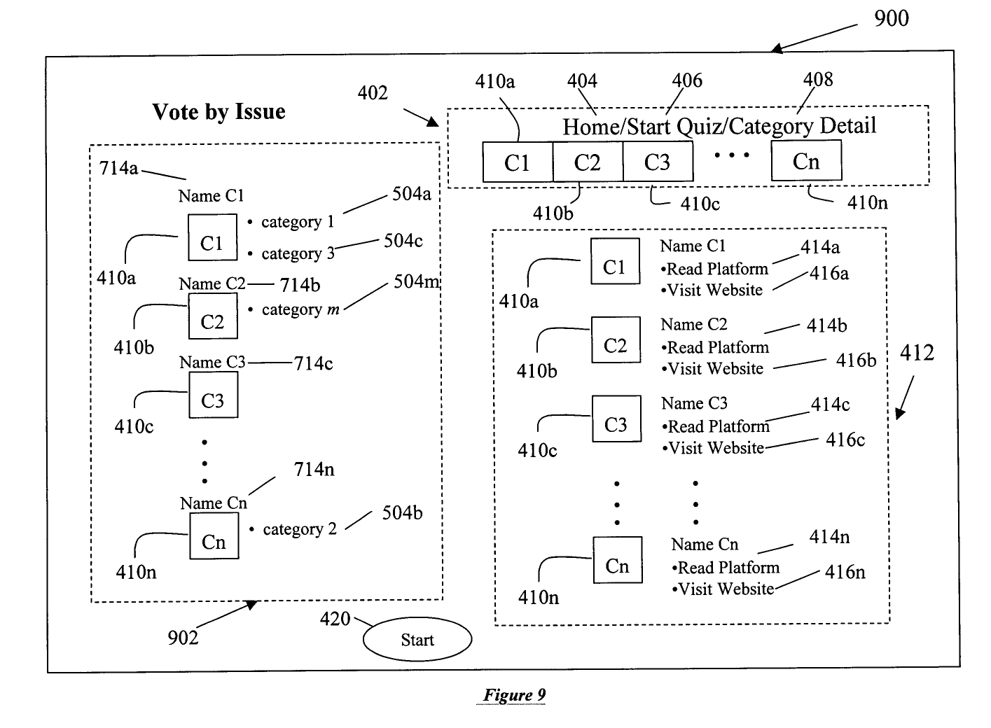

FIG. 9 is a conceptual drawing of a results display screen 900 presented to the user in response to the user completing the questionnaire or otherwise stopping the questionnaire to view the results. The results display screen 900 includes a candidate-category correlation area 902. Within the candidate-category correlation area 902, the system displays the candidates using the identifiers as previously described above with respect to FIGS. 4 and 7. The system also displays an indication of which categories (e.g. issues) for which the user agrees with each candidate, as determined by the user's previous attribute (e.g., point of view) selections. By way of example, the illustrative results display screen 900 depicts the user's selected preference for attributes (e.g. points of view) for categories (e.g. issues) 504a and 504c that correspond to a preference for candidate 410a. Thus, in this illustrative embodiment, the user's attributes preferences for categories 1 and 3, 504a and 504c, matched the attributes of candidate 410a for those same categories, 504a and 504c, whereas for category 504m, the user's preferred attribute matched the attribute of candidate 410b for that category, 504m. Depending on the user's responses at the illustrative attribute selection display screen 800, for a particular candidate the candidate-category correlation field 902 may have a plurality of categories or may even have none.

In an alternative illustrative embodiment, the display screen 900 identifies the candidate that scores highest as determined by the user's previous attribute selections. In another illustrative embodiment, display screen 900 displays an order ranking of candidates as determined by the user's previous attribute selections. In a further illustrative embodiment, the display screen 900 displays an order ranking of candidates that reflects the user's attribute selections and accounts for the user's previous weighting or ranking of categories.

The user may start the questionnaire again by selecting the “Start” function 420, may navigate to different screens using the main menu bar 402, or may retrieve more information for a candidate using the functions available in the candidate summary area 412. Also, as mentioned above, in various illustrative embodiments the display screen 900 may present any suitable scoring or ranking to express a user's preference in a particular candidate.

Changes and modification may be made to the invention without departing from the scope and spirit of the invention. Accordingly, the particular combinations of parts described and illustrated herein is intended to represent only an illustrative embodiment of the invention, and is not intended to serve as limitations of alternative embodiments.

What is claimed is:

1. An automated method for determining a preference for a candidate comprising,
uniquely associating an attribute for each of a plurality of categories with each of a plurality of candidates,
displaying to a user a summary of each candidate's attribute, for each of the plurality of categories,
enabling the user to indicate a preference for at least one of the one of the attributes for each of the plurality of categories,
processing the uniquely associated attributes selected by the user for each of the plurality of categories to identify a user preference for at least one of the candidates, and
displaying the user preference.

2. The method of claim 1 wherein indicating a preference for an attribute includes selecting a single one of the attributes.

3. The method of claim 1 wherein the indicating of a preference comprises ranking a preference for more than one of the attributes.

4. The method of claim 1 wherein the indicating of a preference comprises providing a score for more than one of the attributes.

5. The method of claim 1 wherein each of the attributes comprises a point of view, the plurality of candidates comprises people campaigning for office, and the plurality of categories comprises issues relevant in an election.

6. The method of claim 2 wherein the point of view is expressed by using standardized language.

7. The method of claim 1 wherein the system presents each of the plurality of categories in substantially random or pseudo random order.

8. The method of claim 1 wherein the identity of each of the plurality of candidates associated with the attribute is not revealed to the user until the system displays the user preference.

9. The method of claim 1 comprising enabling the user to indicate the relative importance of each of the plurality of categories.

10. The method of claim 1 comprising enabling the user to exclude from consideration at least one of the plurality of categories.

11. The method of claim 1 comprising ranking the plurality of candidates according to the user's identified preference.

12. The method of claim 1 comprising providing a score with respect the plurality of candidates wherein the score is indicative of the user's preference.

13. The method of claim 1 comprising enabling a user to retrieve a position paper for each attribute.

14. The method of claim 1 wherein the user may stop the system before all the categories have been presented, and the system displays to the user the preferred candidate by category.

15. The method of claim 1 further comprising the step of enabling the user to skip the attribute.

16. The method of claim 1 wherein the user may retrieve a summary of each of the plurality of candidate's attributes for all of the categories.
